(19) United States
(12) Patent Application Publication
(10) Pub. No.: US 2009/0274212 A1
(43) Pub. Date: Nov. 5, 2009

(54) Semiconductor Device Having Moving Image Transcoder and Transcoding Method Therefor

(75) Inventors: Tatsuya Mizutani, Tokyo (JP); Hiroaki Sugita, Tokyo (JP)

Correspondence Address: SPRINKLE IP LAW GROUP, 1301 W. 25TH STREET, SUITE 408, AUSTIN, TX, 78705, US

(73) Assignee: Kabushiki Kaisha Toshiba, Tokyo (JP)

(21) Appl. No.: 12/431,521

(22) Filed: Apr. 28, 2009

(30) Foreign Application Priority Data
Apr. 30, 2008 (JP) P2008-119067

(51) Int. Cl. H04N 7/32; H04N 7/26

(52) U.S. Cl. 375/240.12; 375/240.01; 375/E07.198; 375/E07.243

(57) ABSTRACT

Embodiments include systems and methods for transcoding moving image data. Specifically, in one embodiment, moving image data encoded in a first format can be time divided into a plurality of segments and transmission segments formed from these segments. Each transmission segments can correspond to a particular segment of the moving image data and include the moving image data of that segment plus terminal end data from a preceding segment. One or more second terminals can receive these transmission segments from the first terminal and, working at least partially in parallel, generate second encoded portions from a transmission segment by decoding the moving image data in the first format from the transmission segment using the terminal end data included in the transmission segment and encoding the moving image data in the second format. Moving image data encoded in the second format may be generated by connecting these second encoded portions.

### CROSS-REFERENCE TO RELATED APPLICATIONS

This application claims the benefit of priority to Japanese Patent Application No. P2008-119067, entitled “Semiconductor Device Having Moving Image Transcoder and Transcoding Method Therefor”, filed Apr. 30, 2008 by inventors Tatsuya Mizutani and Hiroaki Sugita, the entire contents of which is hereby incorporated by reference.

### FIELD OF THE INVENTION

The present invention relates to a moving image transcoder and a method therefor. Particularly, the invention relates to a moving image transcoder and a method for the same, which time-divides successive moving image signals encoded in an encoding scheme into multiple segments and which transcodes the multiple time-divided segments into moving image signals in another encoding scheme.

### BACKGROUND

Heretofore, several methods have been known for achieving high-speed encoding through parallel processing using multiple processors or multiple hardware devices in accordance with an international video compression standard such as MPE-2, MPE-3, or H.264.

There is a known time-division method for parallel processing in which multiple segments each including multiple frames successive in time are parallelized by treating one segment as one processing unit.

In performing encoding in parallel by the time-division method, data need to be divided and encoded so as to enable continuous reproduction by eliminating a dependent relationship between divided units and by connecting divided and encoded data. To this end, at each divided point, the divided and encoded data are required to satisfy all of: (A) connectivity at a virtual buffer level, (B) continuity in field phase, and (C) termination of prediction between frames.

To satisfy the first point (A) of the connectivity at a virtual buffer level, divided and encoded data need to be controlled to be at a certain virtual buffer level at each division point. For this purpose, generation rates around a start point and an end point of pieces of data at the division point are controlled. This control enables pieces of divided and encoded data to be successively connected to one another.

To satisfy the second point (B) of the connectivity in field phase, if the field phases in a start point and an end point of data at each division point are controlled in advance to have predetermined values, pieces of divided and encoded data can be successively connected to one another.

To satisfy the third point (C) of the making of a termination of prediction between frames, prediction between frames is preformed only within each division unit, and prediction between frames is not performed over division units.

However, the termination of prediction between frames means not to use the prediction between frames, so that encoding efficiency is usually reduced. However, by increasing the size of a division unit, namely, the number of frames being continuously encoded, the reduction in encoding efficiency can be sufficiently suppressed.

Further, when performing parallel encoding on a moving image signal recorded on a randomly accessible storage medium, time division encoding effectively functions for the parallel encoding. For example, for time division encoding on an image signal in accordance with a conventional encoding scheme such as MPEG-2, the virtual buffer level, the field phase, and the prediction between frames are controlled at an end point of each division encoding unit, which enables connecting of divided and encoded data to one another to thereby perform a continuous reproduction based on the data.

Meanwhile, parallel encoding in units of a time-divided segment is performed also for a moving image signal encoded in accordance with a moving image encoding scheme such as H.264.

An application technique of the time division encoding such as above has been proposed for transcoding process.

The transcoding process is processing in which data encoded in accordance with an encoding scheme are converted into different parameters in another encoding scheme or in the same encoding scheme. The technique proposed above reduces the deterioration of picture quality around a connecting point of segments by connecting divided segments with each other at a point of a scene change.

However, in the case of the proposed techniques, a decoding process and a scene change detection must be performed also on overlapping portions between segments. However, such overlapping portions are to be discarded from resultant transcoded data. Thus, the proposed techniques have a problem of requiring time for such wasteful processes.

An object of the invention is to provide a moving image transcoder and a method therefor which enable a reduction in deterioration of picture quality at a connection point of segments without performing such scene change detection.

### SUMMARY OF THE INVENTION

One or more of the problems outlined above may be solved by the various embodiments of the invention. Broadly speaking, the invention includes systems, semiconductor device and method for transcoding moving image data. One embodiment includes a system for transcoding moving image data. The system includes a data store for storing moving image data, for example, encoded in different formats and a semiconductor device for the transcoding of moving image data. The semiconductor device includes a set of terminals, including a first terminal configured to time-divide moving image data encoded in a first format into a plurality of segments and form transmission segments from these segments. Each transmission segment can correspond to a particular segment of the moving image data and include the moving image data of that segment plus terminal end data of the segment preceding that particular segment. One or more second terminals can receive these transmission segments from the first terminal and, working at least partially in parallel, generate second encoded portions from a transmission segment. The generation of a second encoded portion from a particular transmission segment may entail decoding the moving image data in the first format from the transmission segment using the terminal end data included in the transmission segment and encoding the moving image data in the second format. This moving image data encoded in the second format can then be used to form the second encoded portion. The first terminal receives, from each of the second terminals, the second encoded portions corresponding to each of the transmission segments and generates moving image data encoded in the second format by, for example, connecting these second encoded portions.

In accordance with the invention, the moving image transcoder and the method therefor are achievable, which enable the reduction in the deterioration of picture quality at a connection point of segments without performing the scene change detection.

### BRIEF DESCRIPTION OF THE DRAWINGS

FIG. 1 is a configuration diagram showing a configuration of a moving image transcoder of an embodiment of the invention;

FIG. 2 is a block diagram showing an example of a configuration of a terminal thereof;

FIG. 3 is a diagram for describing a flow of the entire transcoding process thereof;

FIG. 4 is a flowchart showing an example of the flow of process of a terminal 11 thereof;

FIG. 5 is a diagram for describing contents of segment division process thereof;

FIG. 6 is a flowchart for describing an example of the flow of transcoding process at a terminal 12 thereof;

FIG. 7 is a diagram for describing an amount of occupancy of CPB at a terminal end and a head of division points, of the embodiment thereof;

FIG. 8 is a diagram for describing temporary encoding on one overlapping GOP thereof; and

FIG. 9 is a flowchart showing an example of the flow of process of a terminal 11 of a transcoder of a modification of the embodiment of the invention.

### DETAILED DESCRIPTION OF THE PREFERRED EMBODIMENTS

An embodiment of the invention is described below with reference to the accompanying drawings.

### (Device Configuration)

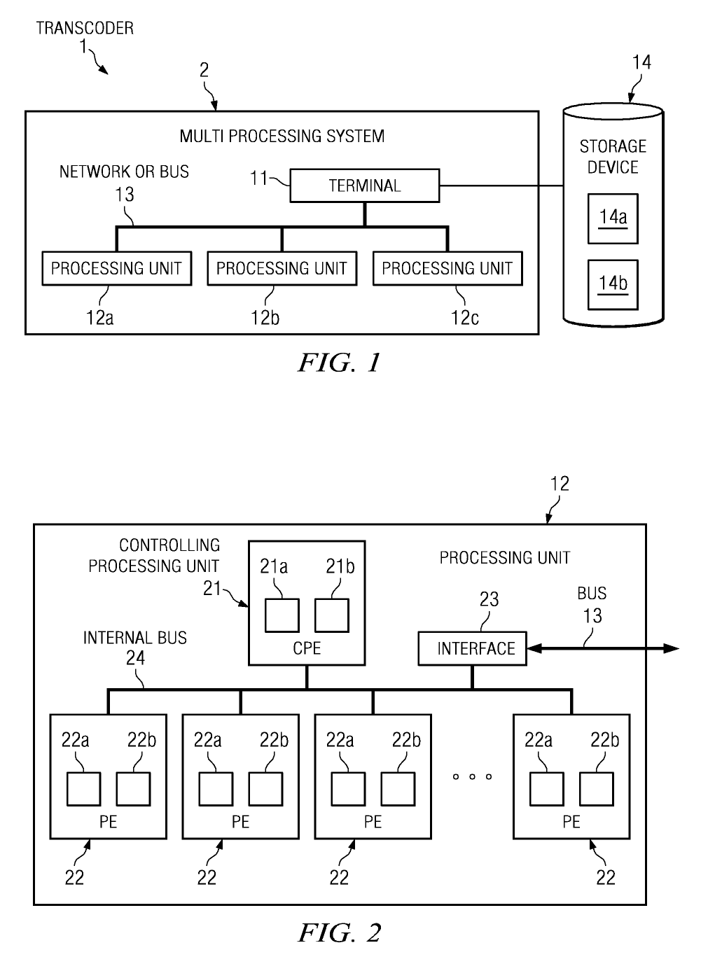

First, a configuration of a system of this embodiment is described with reference to FIG. 1. FIG. 1 is a configuration diagram showing a configuration of a moving image transcoder of this embodiment.

A moving image transcoder 1 includes a terminal device 11 as a client device, and multiple terminal devices as server devices. The terminal device (hereinafter simply referred to as a terminal) 11 and the multiple terminal devices are connected to each other via a network 13 such as a LAN or the Internet. A storage device 14 storing therein content data of moving images is connected to the terminal 11.

Meanwhile, here, the moving image transcoder 1 includes terminals 12a, 12b, 12c (hereinafter individually or collectively referred to as the terminal 12 or the terminals 12) as three server devices. However, there may be one, two, or more server devices. Meanwhile, the moving image transcoder 1 comprises multi processor system 2 and storage device 14. Multi processor system 2 comprises terminal device 11 and terminal devices 12, in such case, terminal device 11 is main processor and terminal 12 is co-processor. Terminal device 11 controls terminal device 12.

The storage device 14 including a storage area 14a in which moving image content data encoded in accordance with a certain encoding scheme are stored is connected to the terminal 11 being a client device. A user performs a predetermined operation on the terminal 11, by which moving image content data are read from the storage device 14 so that segment data are transmitted to the multiple terminals 12. At each terminal 12, received segment data encoded in the certain encoding scheme are transformed, namely transcoded, into segment data encoded in another encoding scheme, and the data thus transformed are transmitted to the terminal 11. At the terminal 11, pieces of the transcoded segment data received from each terminal 12 are connected with each other and stored in a predetermined storage area 14b of the storage device 14.

FIG. 2 is a block diagram showing an example of a configuration of the terminal 12. The terminal 12 includes a control processing unit (hereinafter referred to as CPE) 21, multiple processing units (hereinafter referred to as PEs) 22, and an interface unit (hereinafter referred to as an I/F unit) 23 for the outside. The CPE 21, the multiple PEs 22, and the I/F unit 23 are connected to each other via an internal bus 24.

The CPE 21 includes an arithmetic unit 21a including a controller 21a, and a cache memory 21b. Each of the PEs 22 includes an arithmetic unit 22a and a local memory 22b. In response to a request from the CPE 21, the PEs 22 execute, in parallel, a program of performing a transcoding process on segment data received via the I/F unit 23. The CPE 21 transmits segment data thus transcoded to the terminal 11 via the I/F unit 23.

Further, a configuration of the terminal 11 is the same as that of the terminal 12, so that further description thereof is omitted in this specification.

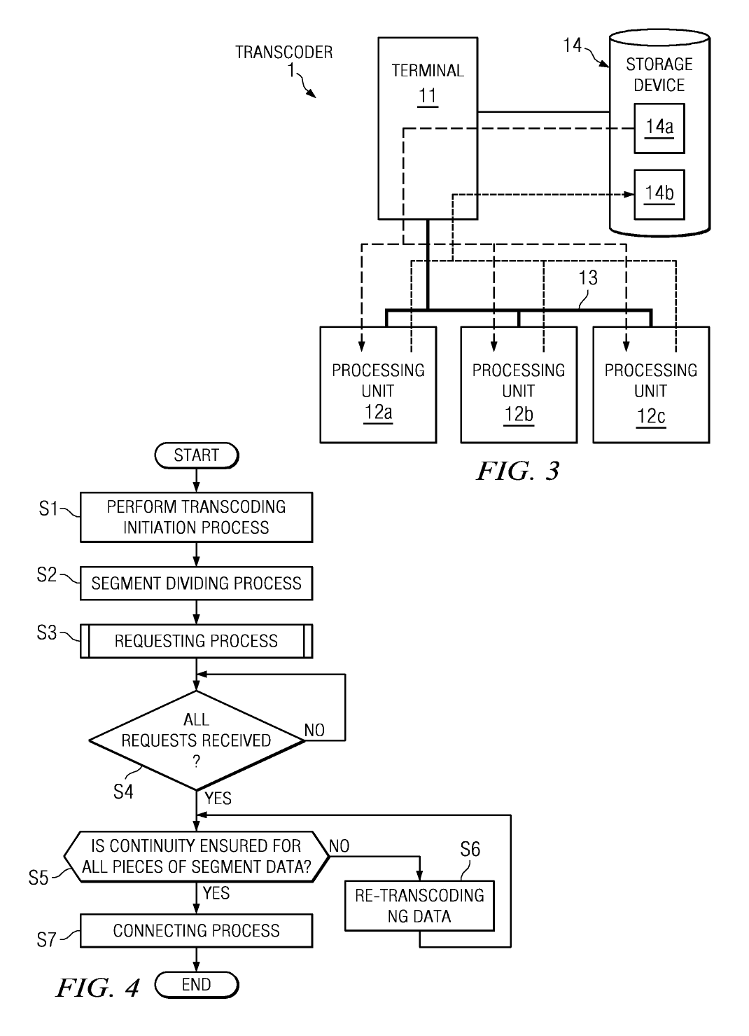

FIG. 3 is a diagram for describing a flow of the entire transcoding process. Moving image content data encoded in accordance with an encoding scheme, namely encoded moving image data; are stored in the storage area 14a of the storage device, as described above. To transform the encoded moving image data into data in another encoding, the terminal 11 time-divides the encoded moving image data into multiple pieces of segment data, and requests multiple terminals 12 to perform the transcoding process on these pieces of segment data. Each terminal 12 performs the transcoding process on received segment data, and transmits the segment data thus transcoded to the terminal 11.

The terminal 11 performs a connecting process on the transcoded segment data transmitted from each terminal 12, and stores the thus obtained transcoded segment data in the predetermined storage area 14b of the storage device 14 as moving image content data encoded in another encoding scheme, namely, encoded moving image data.

For the performing of the transcoding process on each piece of divided segment data, the terminal 11 may make a request to the terminals 12a to 12c in a predetermined order, or may make a request to any one, of the terminals 12a to 12c, which is available, namely a free terminal, for the performing.

In the following, an example is described, in which data in MPEG-2 are stored in a storage area 14a, and data in H.264 transcoded from the data in MPEG-2 are stored in a storage area 14b.

### (Process at Terminal 11)

FIG. 4 is a flowchart showing an example of a flow of a process of a terminal 11.

The terminal 11, first, performs a transcoding initializing process (Step S1), sets encoding parameters such as bit rates of data in H.264 obtained by transcoding data in MPEG-2, and performs similar tasks.

Next, the terminal 11 performs a segment division process (Step S2) to divide all the pieces of encoded moving image data, to be transcoded, into multiple pieces of segment data (hereinafter also simply referred to as segments) including multiple successive frames. A process of Step S2 includes the segment division unit by which encoded moving image data are time-divided into multiple segments.

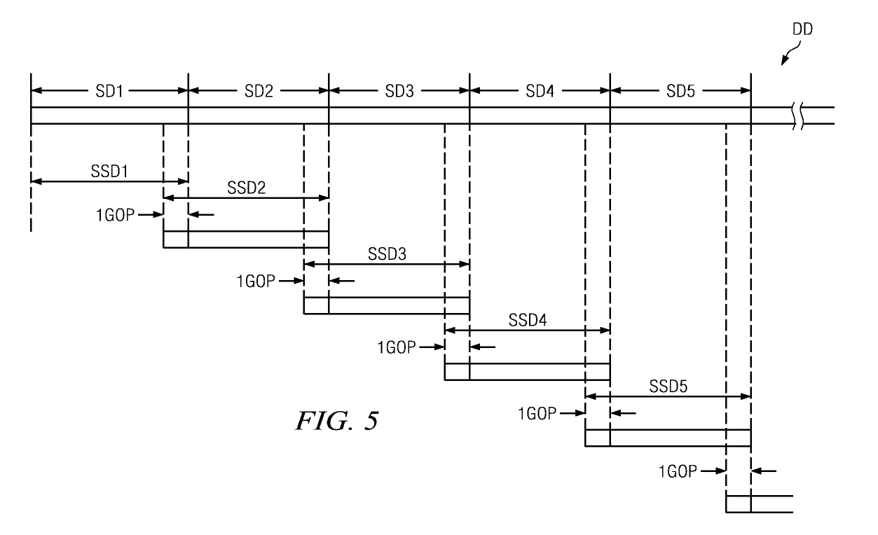

FIG. 5 is a diagram for describing contents of the segment division process. All the pieces of encoded moving image data DD to be transcoded are divided from the head of the data in units of a predetermined amount of data.

The dividing of the segments is performed on a boundary of a GOP structure, with the GOP structure serving as a unit. However, for an open GOP structure, segment division is made so that a referring frame and a frame to be referred are separated, so that a B frame on the head of the GOP is not capable of being decoded. Therefore, as described later, data to which a last one GOP of a segment immediately preceding in time is added are transmitted to the terminal 12.

More specifically, as shown in FIG. 5, all the pieces of encoded moving image data DD are divided along a time axis from the head thereof as in SD1, SD2, SD3, SD4, SD5, . . . (hereinafter segment data are also individually or collectively referred to as a segment SD or segments SD). For example, one segment includes units such as 10 GOP (Group Of Pictures) and 100 GOP.

The terminal 11 performs a request process of requesting the multiple terminals 12 to perform the transcoding process on the multiple divided segments SD (Step S3). That is, the terminal 11 transmits the segments SD to each terminal 12 and requests the terminal 12 to perform the transcoding process.

Each terminal 12 performs the transcoding process in sequence on the segments SD thus divided. As described above, since the multiple PEs 22 are included in the terminal 12 as described above, the transcoding processes for segments SD are performed in parallel. Meanwhile, when each terminal 12 includes only one transcoding process means, the transcoding processes for segments SD are performed in succession; further, when each terminal 12 includes multiple identical transcoding process means, the transcoding processes for multiple segments SD are performed independently and in parallel.

Further, upon completion of the performing of the transcoding process on each received piece of segments SD in MPEG-2, each terminal 12 transmits encoded moving image data in H.264 generated by the transcoding process.

Returning to FIG. 4, the terminal 11 determines whether all pieces of encoded moving image data obtained by transcoding all segments SD are received (Step S4). If all pieces of encoded moving image data of all segments SD are not received, NO is determined in Step S4, and no process is performed.

If all pieces of encoded moving image data of all segments SD are received, YES is determined in Step S4, and, between successive segments arranged in order from the first to the last, the terminal 11 makes comparison between an amount of occupancy of CPB at a segment terminal end and an initial CPB of another segment subsequent thereto. A method of comparing amounts of occupancy of CPB is described later.

That is, the terminal 11 determines whether the continuity of CPB is ensured for all pieces of encoded moving image data of all segments, i.e., whether there is no problem on the continuity of CPB (Step S5).

The terminal 11 checks the continuity of CPB between two pieces of encoded moving image data, in H.264, of the first segment SD1 and the second segment SD2. When the continuity of CPB is ensured between the segments SD1 and SD2, the terminal 11 further checks the continuity of CPB between two pieces of encoded moving image data, in H.264, of the next two segments SD2 and SD3. When the continuity of CPB between the segments SD2 and SD3 is ensured, the continuity of CPB is, further, checked between two pieces of encoded moving image data, in H.264, of the next two segments SD3 and SD4. In this manner, the continuity of CPB between two segments is successively checked.

When the continuity of CPB between two segments SD is not ensured, NO is determined in Step S5, and the terminal 11 performs a re-transcoding process on segments between which the continuity of CPB is not ensured (Step S6). The re-transcoding process is performed on all the segments until the continuity of CPB is ensured. The re-transcoding process is described later. Step S6 includes a re-encoding unit by which a re-encoding is performed when two successive pieces of encoded moving image data do not satisfy a predetermined condition.

In the above-described manner, at the terminal 11, the continuity of CPB between two successive segments is checked, and a necessary re-transcoding process is performed to ensure the continuity, so that encoded moving image data capable of being continuously reproduced without discontinuity are generated and outputted. The transcoding process is, thereafter, terminated.

Thus, by time-dividing successive encoded moving image data into multiple segments and by transcoding the segments independently and in parallel, a fast transcoding process becomes possible depending on the degree of parallelism, and the same pieces of encoded moving image data are capable of being generated independent of the degree of parallelism.

Further, when the continuity of CPB is ensured between two neighboring segments of all the segments to be transcoded, YES is determined in Step S5, and the terminal 11 performs a connecting process by which all pieces of encoded moving image data of all the received and transcoded segments are connected (Step S7). Step 7 includes a connecting unit by which multiple second encoded moving image data, corresponding respectively to multiple segments, are connected.

Encoded moving image data of multiple segments on which the connecting process is performed are stored in the storage area 14b as moving image content data encoded in the encoding scheme of H.264.

As shown in FIG. 5, all the pieces of encoded moving image data DD are divided from the head of data in units of a predetermined amount of data, but transmission segment data (hereinafter referred to as a transmission segment) SSD transmitted from the terminal 11 to the terminal 12 are data to which a last one GOP of the immediately preceding segment is added, with the first segment SD1 excluded. In other words, the transmission segment SSD represents data which include: data of a certain time-divided segment; and part of data including data at a terminal end of another different segment immediately preceding the certain segment on a time sequence. As shown in FIG. 5, in a transmission segment SSD corresponding to the certain segment, data corresponding to one GOP, which are the data including those at a terminal end of the different segment immediately preceding the certain segment on a time sequence, partly overlap data of another transmission segment SSD immediately preceding the above transmission segment.

This is to prevent a decoding process from abnormally being performed in a decoding process for the transcoding process in the terminal 12, when a frame referring to a frame preceding a division point of a segment is included in the segment SD. When data not normally decoded are encoded in the transcoding process, data including an abnormal frame are generated.

Accordingly, data to be transmitted to the terminal 12 are set as the above-described transmission segment SSD. The transmission segment SSD represents data to which, at the head of the segment SD, a last one GOP of the immediately preceding segment SD is copied and added. In an amount of data corresponding one GOP, one frame is inevitably included. Therefore, decoded data do not include an abnormal frame such as above in the decoding process for the transcoding process of the segment SD.

As shown in FIG. 5, for the first segment data SD1, since there is no immediately preceding segment SD, the segment SD1 becomes a transmission segment SSD1 as it is, but for a subsequent segment SD, data to which data of a last one GOP of the preceding segment are added become a transmission segment SSD.

The terminal 12 transmits to the terminal 11 segment data TSD obtained by transcoding each segment SD.

### (Process of Terminal 12)

A process at the terminal 12 is described.

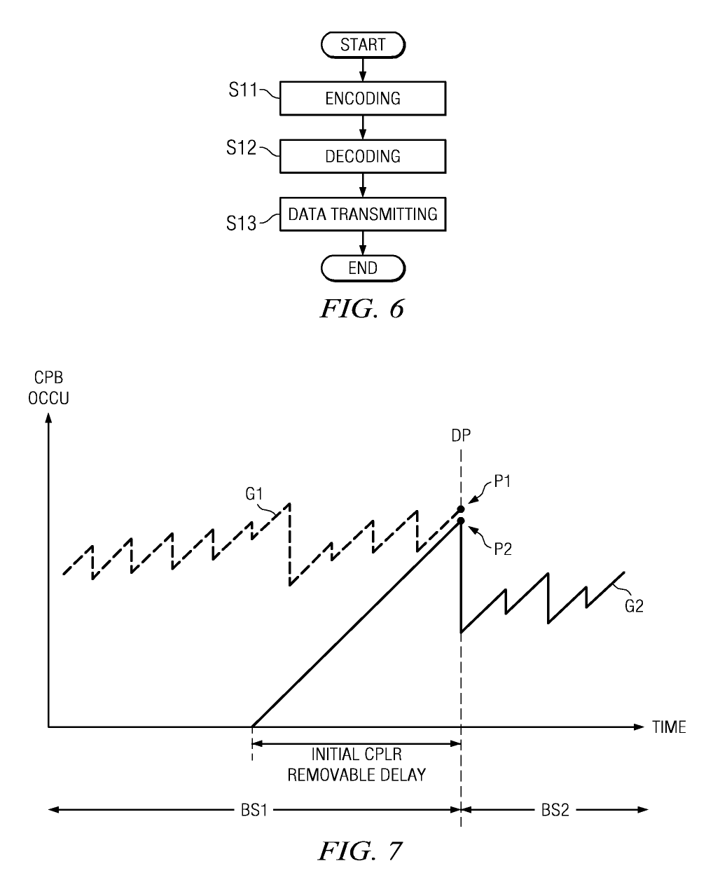

FIG. 6 is a flowchart for describing an example of the flow of transcoding process at the terminal 12.

Upon receiving a transmission segment SSD requested to be transcoded, the terminal 12 performs a process of FIG. 6.

First, the overall process is briefly described.

Since a received segment represents encoded moving image data encoded in the encoding scheme of MPEG2, the terminal 12, first, performs a decoding process in MPEG2 (Step S11). In Step S11, as described above, using a last one GOP of the immediately preceding segment SD, a decoding process is performed on each transmission segment SSD, and moving image data of the segment SD are generated. Here, the last one GOP of the immediately preceding segment SD is used in a decoding method of the segment.

Next, the terminal 12 performs an encoding process in the encoding scheme of H.264 on generated moving image data (Step S12).

Further, the terminal 12 performs a data transmission process to transmit, to the terminal 11, encoded moving image data, of each segment, on which an encoding process is performed using the encoding scheme of H.264 (Step S13).

Meanwhile, in the standard of H.264, it is essential to insert, at the head of a GOP in a bit stream, information of buffering period SEI which includes an initial_cpb_removal_delay representing an amount of delay from a receipt of bit stream to a start of a decoding process. This information is essential for the encoding of moving image data in the encoding scheme of H.264.

When encoding moving image data without dividing, it is possible to automatically calculate the initial_cpb_removal_delay using an amount of occupancy of a coded picture buffer (hereinafter referred to as CPB) present in an encoder, and also the continuity of CPB is ensured.

However, when encoding divided moving image data, the amount of occupancy of CPB at a terminal end of a bit stream of the immediately preceding segment SD is not clear, the amount of occupancy of CPB being information of an encoding result of the immediately preceding segment SD, so that the initial_cpb_removal_delay at the head of a bit stream to be encoded is not capable of being automatically calculated.

Therefore, when encoding divided moving image data, it is essential to determine, before starting encoding, a first initial_cpb_removal_delay of a subsequent segment on a time sequence on all the division points, namely connecting positions, and to perform a control to satisfy a constrain condition at a terminal end of each segment. The constrain condition is that in terms of the amount of occupancy of CPB being virtual buffer information, the amount of occupancy of CPB, on a division point, at a terminal end of a preceding segment SD on a time sequence exceeds an initial amount of occupancy of CPB of the head of a bit stream of a segment subsequent to the preceding segment.

In the control by which the constrain condition at a terminal end of each division point is satisfied, each encoder first calculates the next initial amount of occupancy of CPB being a target using an initial_cpb_removal_delay of the head of the next division point determined in advance, and based on the calculated amount of occupancy of CPB, adjusts an amount of occupancy of CPB at a terminal end by bit rate control so as to satisfy the above-described constraint condition.

FIG. 7 is a diagram for describing an amount of occupancy of CPB at an terminal end and a head of division points, namely connecting positions. Under the above constraint condition, the amount of occupancy of CPB of a bit stream BS1 of a preceding segment SD of two successive segments changes as shown in a dashed-dotted line G1. An amount of occupancy P1 of CPB at a terminal end of the bit stream BS1 of the preceding segment SD must be not less than an initial amount of occupancy P2 of CPB of a bit stream BS2 of a segment SD subsequent to the preceding segment SD.

As the way of determining an initial_cpb_removal_delay at the head of a bit stream of each segment SD, there is a method in which all values are equal, for example. However, this method has a problem that it is difficult to perform a flexible bit rate control since the bit rate is controlled so that amounts of occupancy of CPB at two positions of a head and a terminal end of divided bit streams are within a certain range but that the rate at the terminal end is larger than that at the head. To be more precise, in this case, the same bit rate control is performed even for data in a divided bit stream needing a large amount of codes for a scene change or the like, or even for data only needing a small amount of codes. As a result, a sufficient amount of codes is not allocated to data requiring a larger amount of codes, thus causing the deterioration of picture quality.

Therefore, in this embodiment, for moving image data of two successive segments, in one GOP which is located at the head of a preceding transmission segment SSD, and which overlaps a transmission segment SSD immediately preceding the preceding transmission segment SSD, one or more normally decoded frames are temporarily encoded, and based on an amount of codes at the time of the temporary encoding, an amount of occupancy of CPB at a terminal end of stream data of the preceding segment SD is predicted.

That is, when performing an encoding process in Step S12, the terminal 12 acquires, as a prediction value of virtual buffer information, an amount of occupancy of CPB at a terminal end of stream data of the preceding segment SD by temporarily encoding part of data including terminal end data of the preceding segment. Further, using the prediction value, for a transmission segment SSD, the terminal 12 performs an encoding process on part of moving image data which does not overlap another transmission segment SSD immediately preceding the above transmission segment SSD.

### (Temporary Encoding Process)

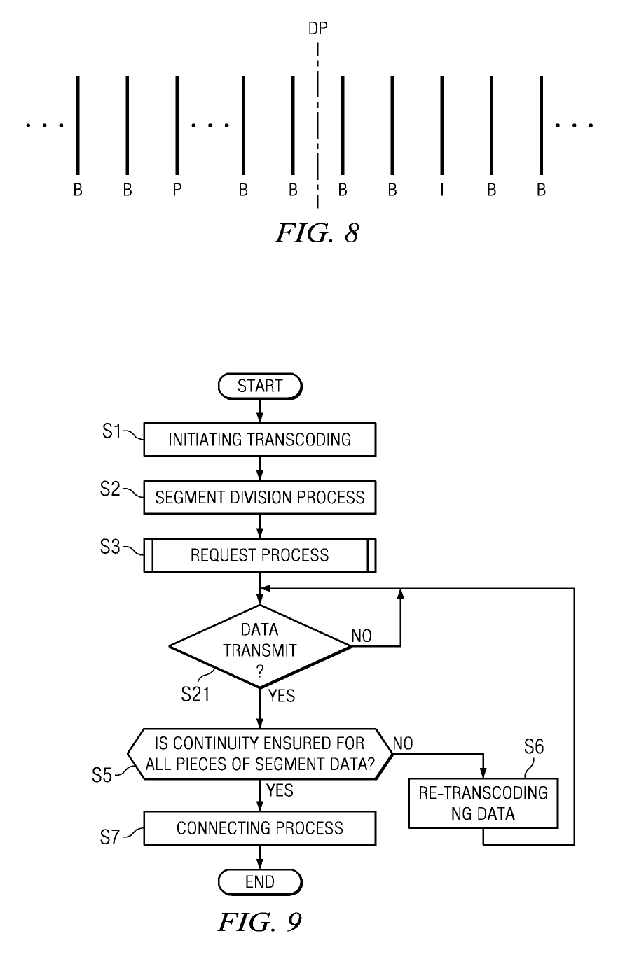

FIG. 8 is a diagram for describing temporary encoding on one overlapping GOP. As shown in FIG. 8, as a result of the decoding of a segment SD, when assuming the presence of an anterior segment SD, preceding in time a division position or a connecting position DP, and a posterior segment SD subsequent thereto, an initial_cpb_removal_delay of a head of bit stream data of the posterior segment SD is determined by temporarily encoding a frame normally decoded in image data of the one GOP.

As shown in FIG. 8, for example, when a last one GOP of the anterior segment starts from two B frames, the first two B frames are not normally decoded, but frames subsequent thereafter are normally decoded. Thus, only frames normally decoded in the last one GOP of the former segment are used for temporary encoding.

When performing temporary encoding in the encoding scheme of H.264 using the normally decoded frames, an amount of occupancy of CPB at the time of starting the temporary encoding is, for example, one third of a CPB size.

An amount of occupancy of CPB at the level of which the temporary encoding is performed on and up to the last frame of one GOP is set as an initial amount of occupancy of CPB of an encoding process of a second or subsequent GOP. Further, using the initial amount of occupancy of CPB, a value of an initial_cpb_removal_delay is calculated, and the value of the initial_cpb_removal_delay acquired as a result of the calculation is set in a bit stream as an initial_cpb_removal_delay of the following segment.

By predicting the initial amount of occupancy of CPB of the bit stream BS2 of a segment as described above, a flexible control is capable of being performed so that an amount of occupancy of CPB at a terminal end of the segment satisfies the constraint condition, and eventually, the quality of transcoded picture is capable of being enhanced.

Further, there is a possibility that a prediction value, acquired by temporary encoding, of an amount of occupancy of CPB at a terminal end of a preceding segment becomes less than an actual amount of occupancy of CPB due to a prediction error. when it occurs, and when connecting bit streams of multiple segments, an amount of occupancy of CPB at a terminal end of a segment preceding the division position DP becomes less than an initial amount of occupancy of CPB of a subsequent segment, so that the continuity of CPB is no longer ensured.

Therefore, in order to avoid such a state, after transcoding all the segments in Step S5 of FIG. 4 in this embodiment, the continuity of CPB is checked. To be more specific, a check is made, in order from the second segment, whether an initial amount of occupancy of CPB of each segment is less than that of a preceding segment. When the initial amount of occupancy of CPB of a certain segment is larger than that of a preceding segment, the transcoding process is newly performed on the certain segment. More specifically, the terminal 11 newly requests the terminal 12 to perform the transcoding process, and at that time, the amount of occupancy of CPB at the terminal end of the preceding segment is set as an initial amount of occupancy of CPB. By setting the amount of occupancy of CPB at the terminal end of the preceding segment as the initial amount of occupancy of CPB, and by newly making a request to perform the transcoding process in the above-described manner, the continuity of CPB is ensured.

Further, a check on the continuity of CPB is made in order from the first segment, and when the initial amount of occupancy of CPB of a certain segment is larger than that of a preceding segment, the transcoding process is newly performed on the certain segment. Accordingly, between the preceding segment and the segment on which a re-transcoding process has been performed, the continuity of CPB is maintained, but due to this re-transcoding process, the continuity of CPB may no longer be maintained in some cases for segments subsequent in time to the re-transcoded segment.

Therefore, when NO is determined in Step S5, a re-transcoding process is performed on that segment in Step S6. After the process, the continuity of CPB is checked in Step S5 for all the segments subsequent in time to a segment of bit stream acquired by the re-transcoding process.

Consequently, in Step S5, the remaining segments are checked and determined not to have CPB continuity, and a re-transcoding process is performed multiple times in some cases. Eventually, in Step S5, when it is determined that the continuity of CPB is ensured between all the segments, a connecting process is performed in Step S7.

### (Modification)

Modification of the above-described embodiment is described below.

For the transcoder of the above embodiment, a check on whether the continuity of an amount of occupancy of CPB is ensured at the time of connecting segments is made after completing the transcoding of all the segments, while not limited thereto.

For example, even when not completing the transcoding process on all the segments, after completing the transcoding process on each segment, a check may be made in order from a bit stream corresponding to a leading segment. In other words, a check may be made in order from a bit stream corresponding to a leading segment along with an encoding process on each segment. In this case, the transcoding process is performed at the time when a segment for the performing of the transcoding process is found. It is only necessary to ensure the continuity of an amount of occupancy of CPB on connecting positions being boundaries of all the segments, and there is no particular limitation with respect to the performing of the transcoding process and to the order of re-performing.

FIG. 9 is a flowchart showing an example of the flow of process in the terminal 11 of a transcoder of the modification. Processes of FIG. 9 include those same as processes of FIG. 4, so that processes which are the same as those of FIG. 4 are designated by the same reference numerals and symbols, and that further description thereof is omitted in this specification.

The terminal 11 is supposed to receive bit stream data in H.264 which are generated by terminals 12 with the transcoding process and which correspond to segments respectively, so that it is determined whether the terminal 11 has received such bit stream data in H.264 corresponding to the respective segments (Step S21). When the terminal 11 receives a bit stream of a segment SD from the terminal 12, YES is determined in Step S21. Thereafter, for two successive segments, in order from a segment first received, the terminal 11 makes a comparison between an amount of occupancy of CPB at a terminal end of a segment, and an initial amount of occupancy of CPB of another segment subsequent thereto, and also checks the continuity of CPB. The terminal 11 determines whether the continuity of CPB is ensured, i.e. whether there is no problem on the continuity of CPB (Step S5).

When not completing the performing of the transcoding process on all the segments, and when the continuity of CPB between two successive segments SD is not ensured for all the segments, NO is determined in Step S5, the terminal 11 performs the re-transcoding process described above (Step S6), and the process returns to Step S21.

It does not mean that the terminal 11 does not check the continuity of CPB until receiving all the encoded moving image data having been transcoded; once receiving encoded moving image data which are transcoded, the terminal 11 checks the continuity of CPB of encoded moving image data which are capable of being compared. When bit stream data with no continuity are found, the re-transcoding process is promptly performed on a segment corresponding to that bit stream data, which means that a quick transcoding process is capable of being achieved.

As described above, the moving image transcoders of the above-described embodiment and modification time-divides encoded moving image data, which are successive in time, into multiple segments, and transcodes each segment independently and in parallel, so that a fast transcoding process becomes possible depending on the degree of parallelism, and so that the generating of encoded moving image data in different encoding scheme from original encoding scheme becomes possible independent of the degree of parallelism.

Further, in the moving image transcoder 1, when performing the transcoding process, frames normally decoded in one GOP are temporarily encoded, the one GOP overlapping a segment SD immediately preceding a target segment SD on a time series. Based on an amount of codes at the time of the temporary encoding, an amount of occupancy of CPB at a terminal end of bit stream data of the segment SD immediately preceding the target segment SD is predicted, and a prediction value thus predicted is set as an initial amount of occupancy of CPB of bit stream data of the target segment SD.

Further, when the continuity of CPB is not ensured due to a prediction or a prediction error, the moving image transcoder 1 re-performs the transcoding process on a segment not ensuring the continuity of CPB.

Therefore, the moving image transcoder is capable of performing a flexible rate control with the continuity of CPB ensured, so that a transcoding result with less picture deterioration can be acquired.

Further, in the transcoder of this embodiment, a portion overlapping between divided segments is one GOP, while not limited thereto. For example, the overlapping portion may be two or more GOPs. At least, the overlapping portion may be data including data enabling generation of a frame in which the head of a non-overlapping segment portion is decodable. Accordingly, in terms of the above, the inclusion of data allowing such a frame to be generated provides neither an upper limit nor a lower limit to an amount of data of the overlapping portion.

Further, in the transcoder of this embodiment, an initial amount of occupancy of CPB of bit stream on which a temporary encoding process is performed is set as one third of a CPB size, while not limited thereto. When increasing the initial amount of occupancy of CPB, the probability of not ensuring the continuity of CPB becomes high, so that the frequency of the re-performing of transcoding becomes high. Meanwhile, however, the degree of flexibility of a rate control is enhanced, hence improving picture quality.

Accordingly, the initial amount of CPB is suitably set in light of the balance between a disadvantage of re-performing the transcoding process, and an advantage of improving picture quality.

In addition, the transcoder of this embodiment has been described using the example in which data in MPEG-2 are used as data on the input side, but the data on the input side may be moving image data in another moving image encoding scheme with constraint similar to MPEG-2, e.g., simple encoding scheme such as PCM encoding is also applicable.

In addition, the transcoder of this embodiment has been described using the example in which data in H.264 are used as data on the output side, while not limited to H.264 for the output data, but data in another moving image encoding scheme with constraint similar to H.264 are also applicable.

Each “unit” in this specification represents a conceptual one corresponding to each function of the embodiment or the modification, and does not necessarily correspond one-to-one to specific hardware, software, or a routine. Accordingly, in this specification, the embodiment has been described with the assumption of a virtual circuit block (unit) having functions of this embodiment. Further, for steps of each procedure of this embodiment, the order of performing the steps may be interchanged, multiple steps may be performed at the same time, or the steps may be performed in a different order at a different time of performing the steps, as long as the steps follow their own characteristics.

All or part of a computer program with which the above-described operations are performed is, as the product of a computer program, recorded on or stored in a flexible disk, a portable medium such as a CD-ROM, or a storage medium such as a hard disk. The program code is read by a computer so that all or some of the operations are performed. Alternatively, all or part of the program code can be circulated or provided via a communication network. Users are each capable of downloading the program code via the communication network and installing the program code in his/her computer, or are each capable of installing the program code in his/her computer from a recording medium, thus easily achieving the moving image transcoder of the invention.

It is to be understood that the present invention is not intended to be limited to the above-described embodiments, and various changes or modifications may be made therein without departing from the spirit of the invention.

What is claimed is:

1. A system for transcoding moving image data, comprising:
a storage device configured to store encoded moving image data; and
a set of terminals, including
a first terminal configured to:
time-divide first encoded moving image data comprising moving image data encoded in a first format into a plurality of segments such that each segment comprises a corresponding first encoded portion of the moving image data and each segment has a preceding segment,
form a plurality of transmission segments from the plurality of segments, each of the plurality of transmission segments corresponding to one of the plurality of segments and comprising the first encoded portion of the moving image data of the corresponding segment and terminal end data from a terminal end of the preceding segment of the corresponding segment,
receive a plurality of second encoded portions of moving image data, each of the plurality of second encoded portions corresponding to one of the plurality of segments, and
generate second encoded moving image data comprising the moving image data encoded in a second format from the second encoded portions of moving image data, and
at least one second terminal, each second terminal configured to:
receive a transmission segment of the plurality of transmission segments,
generate a portion of the moving image data corresponding to the first encoded portion by decoding the first encoded portion of the moving image data of the transmission segment utilizing the terminal end data of the transmission segment, and
generate a second encoded portion by encoding the portion of the moving image data in a second format, and
provide the second encoded portion of the moving image data to the first terminal.

2. The system of claim 1, wherein generating the second encoded portion includes determining a prediction value of virtual buffer information utilizing the terminal end data of the transmission segment.

3. The system of claim 2, wherein determining the prediction value of the virtual buffer information comprises encoding the terminal end data in the second format.

4. The system of claim 3, wherein the prediction value is used to encode the portion of the moving image data in the second format.

5. The system of claim 4, wherein the prediction value corresponds to an amount of occupancy of a coded picture buffer (CPB) of the preceding segment.

6. The system of claim 5, wherein the first terminal is further configured to check the continuity of virtual buffer information for the plurality of second encoded portions, wherein checking the continuity of virtual buffer information for a particular second encoded portion comprises:
determining first virtual buffer information corresponding to the terminal end of the preceding segment of the segment corresponding to the particular second encoded portion using the second encoded portion corresponding to the preceding segment,
determining second virtual buffer information from the prediction value of the particular second encoded portion, and
determining if the second virtual buffer information is larger than the first virtual buffer information.

7. The system of claim 6, wherein the first terminal is further configured to: re-transcode the segment corresponding to the particular second encoded portion if the second virtual buffer information is larger than the first virtual buffer information.

8. The system of claim 7, wherein checking the continuity for each of the plurality of second encoded portion is done after all the second encoded portions are received at the first terminal.

9. The system of claim 8, wherein the first format comprises MPEG-2 and the second format comprises H.264.

10. The system of claim 9, wherein each segment comprises 10 or 100 group of pictures, the time-dividing of the first encoded moving image data is performed on a boundary of a GOP and the terminal end data from the preceding segment comprises a last GOP of the preceding segment.

11. A method for transcoding moving image data, comprising: providing a system including a storage device for storing moving picture data encoded in different formats and a plurality of interconnected terminals;
receiving, at a first terminal, first encoded moving image data comprising moving image data encoded in a first format;
time-dividing, at the first terminal, the first encoded moving image data into a plurality of segments such that each segment comprises a corresponding first encoded portion of the moving image data and each segment has a preceding segment;
forming, at the first terminal, a plurality of transmission segments from the plurality of segments, each of the plurality of transmission segments corresponding to one of the plurality of segments and comprising the first encoded portion of the moving image data of the corresponding segment and terminal end data from a terminal end of the preceding segment of the corresponding segment;
receiving, at a second terminal, a transmission segment of the plurality of transmission segments,
generating, at the second terminal, a portion of the moving image data corresponding to the first encoded portion by decoding the first encoded portion of the moving image data of the transmission segment utilizing the terminal end data of the transmission segment;
generating, at the second terminal, a second encoded portion by encoding the portion of the moving image data in a second format;
transmitting the second encoded portion of the moving image data from the second terminal to the first terminal;
receiving, at the first terminal, a plurality of second encoded portions of moving image data, each of the plurality of second encoded portions corresponding to one of the plurality of segments;
generating, at the first terminal, second encoded moving image data comprising the moving image data encoded in a second format from the second encoded portions of moving image data; and
saving the second encoded moving image data to the storage device.

12. The method of claim 11, wherein generating the second encoded portion at the second terminal includes determining a prediction value of virtual buffer information utilizing the terminal end data of the transmission segment.

13. The method of claim 12, wherein determining the prediction value of the virtual buffer information comprises encoding the terminal end data in the second format.

14. The method of claim 13, wherein the prediction value is used to encode the portion of the moving image data in the second format.

15. The method of claim 14, wherein the prediction value corresponds to an amount of occupancy of a coded picture buffer (CPB) of the preceding segment.

16. The method of claim 15, further comprising, at the first terminal, checking the continuity of virtual buffer information for the plurality of second encoded portions, wherein checking the continuity of virtual buffer information for a particular second encoded portion comprises:
determining first virtual buffer information corresponding to the terminal end of the preceding segment of the segment corresponding to the particular second encoded portion using the second encoded portion corresponding to the preceding segment,
determining second virtual buffer information from the prediction value of the particular second encoded portion, and
determining if the second virtual buffer information is larger than the first virtual buffer information.

17. The method of claim 16, further comprising, at the first terminal, re-transcoding the segment corresponding to the particular second encoded portion if the second virtual buffer information is larger than the first virtual buffer information.

18. The method of claim 17, wherein checking the continuity for each of the plurality of second encoded portion is done after all the second encoded portions are received at the first terminal.

19. The method of claim 18, wherein the first format comprises MPEG-2 and the second format comprises H.264.

20. The method of claim 19, wherein each segment comprises 10 or 100 group of pictures, the time-dividing of the first encoded moving image data is performed on a boundary of a GOP and the terminal end data from the preceding segment comprises a last GOP of the preceding segment.
